(19) United States
(12) Patent Application Publication
(10) Pub. No.: US 2012/0235546 A1
(43) Pub. Date: Sep. 20, 2012

(54) MOTOR

(75) Inventor: Hisashi FUKUZAWA, Nagano (JP)

(73) Assignee: NIDEC SANKYO CORPORATION, Nagano (JP)

(21) Appl. No.: 13/358,926

(22) Filed: Jan. 26, 2012

(30) Foreign Application Priority Data
Mar. 16, 2011 (JP) 2011-057341

(51) Int. Cl. H02K 5/16

(52) U.S. Cl. 310/425

(57) ABSTRACT

A motor may include a rotation shaft, a drive magnet, a drive coil, a case body covering the drive coil, a slide bearing supporting the rotation shaft and movable in an axial direction, and a bearing holder holding the slide bearing movably in the axial direction through an inner peripheral face. The bearing holder is fixed to an opposite-to-output side end face of the case body and an entire bearing holder is disposed on an outer side of the case body and the case body has opening part having a bearing holding face for slidably supporting the slide bearing together with an inner peripheral face of the bearing holder. A part of the slide bearing is disposed in an inside of the case body and the slide bearing is slidably held by the inner peripheral face of the bearing holder and the bearing holding face of the case body.

### CROSS REFERENCE TO RELATED APPLICATION

The present invention claims priority under 35 U.S.C. §119 to Japanese Application No. 2011-057341 filed Mar. 16, 2011, the entire content of which is incorporated herein by reference.

### FIELD OF THE INVENTION

At least an embodiment of the present invention may relate to a motor provided with a slide bearing which supports an end part of a rotation shaft and is movable in an axial direction of the rotation shaft.

### BACKGROUND

Conventionally, a stepping motor has been known as a motor for moving lenses which are used in an optical pickup device for a CD or a DVD player or the like or in a camera (see, for example, Japanese Patent Laid-Open No. 2009-240106 and Japanese Patent Laid-Open No. 2007-20346). In the stepping motor described in the above-mentioned Patent Literatures, an end part on an opposite-to-output side of a rotation shaft is held by a slide bearing which is capable of sliding along an inner peripheral face of a bearing holder. The bearing holder is fixed to an end face on the opposite-to-output side of a case. Further, in the stepping motor described in the former Patent Literature, the entire bearing holder is disposed on an outer side of the case. On the other hand, in the stepping motor described in the latter Patent Literature, a part of a bearing holder is disposed on an outer side of a case and a part of the remaining bearing holder is disposed on an inner side of the case.

In recent years, in a market such as a CD and a DVD player, a camera and the like, the requirement for downsizing of the device is increased, and requirement for downsizing of a stepping motor mounted on the devices is also increased. In the stepping motor described in the former Patent Literature, the entire bearing holder is disposed on the outer side of a case and thus, when the bearing holder is structured to be thin in an axial direction of the rotation shaft, the size of the stepping motor is made small in the axial direction. However, when the bearing holder is made thin in the axial direction, a contact length of the bearing holder with the slide bearing is shortened in the axial direction and thus the bearing holder may be unable to surely hold the slide bearing. Therefore, when the bearing holder is made thin in the axial direction, it may be difficult that the slide bearing is appropriately guided in the axial direction by the bearing holder and that the slide bearing is smoothly slid in the axial direction. In other words, it is difficult that the size of the stepping motor described in the former Patent Literature is reduced in the axial direction.

On the other hand, in the stepping motor described in the latter Patent Literature, even when a thickness of a bearing holder in an axial direction is secured to some extent in order to secure a contact length of the bearing holder with a slide bearing in the axial direction, since a part of the bearing holder is disposed in the inside of a case, the stepping motor can be made small in the axial direction. However, in the stepping motor, since a part of the bearing holder is disposed in the inside of the case, the case is required to be made large in a radial direction by an amount of the bearing holder which is disposed in the inside of the case. Therefore, it is difficult that the size of the stepping motor described in the latter Patent Literature is reduced in the radial direction.

### SUMMARY

In view of the problems described above, at least an embodiment of the present invention may advantageously provide a motor whose size in the axial direction and the radial direction is capable of being reduced even when the slide bearing is smoothly moved in the axial direction.

According to at least an embodiment of the present invention, there may be provided a motor including a rotation shaft, a drive magnet which is fixed to the rotation shaft, a drive coil which is disposed on an outer peripheral side of the drive magnet, a case body which covers at least a part of an outer peripheral face of the drive coil, a slide bearing which supports an end part on an opposite-to-output side of the rotation shaft and is movable in an axial direction of the rotation shaft, and a bearing holder which holds the slide bearing movably in the axial direction through an inner peripheral face of the bearing holder. The bearing holder is fixed to an opposite-to-output side end face of the case body and an entire bearing holder is disposed on an outer side of the case body, and the case body is structured with an opening part having a bearing holding face for slidably supporting the slide bearing together with an inner peripheral face of the bearing holder, and a part of the slide bearing is disposed in the inside of the case body, and the slide bearing is held by the inner peripheral face of the bearing holder and the bearing holding face so as to be movable in the axial direction.

In the motor in accordance with an embodiment of the present invention, the case body is structured with an opening part having a bearing holding face for slidably supporting the slide bearing together with an inner peripheral face of the bearing holder. Further, in accordance with the embodiment of the present invention, a part of the slide bearing is disposed in the inside of the case body, and the slide bearing is held by the inner peripheral face of the bearing holder and the bearing holding face of the case body so as to be movable in the axial direction. Therefore, even when a thickness of the bearing holder in the axial direction is reduced, a contact length in the axial direction of the inner peripheral face of the bearing holder and the bearing holding face of the case body with the slide bearing is secured by utilizing the bearing holding face which is structured in the case body and thus the slide bearing is held appropriately. Accordingly, in the embodiment of the present invention, even when the thickness of the bearing holder in the axial direction is reduced, the slide bearing is appropriately guided in the axial direction by the bearing holding face of the case body and the inner peripheral face of the bearing holder and the slide bearing 7 is smoothly moved in the axial direction. As a result, the size of the motor is reduced in the axial direction. Further, in the embodiment of the present invention, the entire bearing holder is disposed on the outer side of the case body and thus the size in the radial direction of the case body can be determined regardless of the bearing holder. Therefore, in the embodiment of the present invention, the size of the motor can be reduced in the radial direction. As described above, in the embodiment of the present invention, even when the slide bearing is capable of being smoothly moved in the axial direction, the size of the motor can be reduced in the axial direction and the radial direction.

In accordance with an embodiment of the present invention, the opening part of the case body is structured with a recessed part which is recessed to an outer side in a radial direction of the rotation shaft with respect to the bearing holding face. Commonly, a case body is not structured for slidably holding a slide bearing. Therefore, when the slide bearing is held by a bearing holding face of the case body, sliding resistance between the slide bearing and the bearing holding face becomes large and thus the slide bearing may be unable to slide smoothly in the axial direction. However, according to the above-mentioned structure, a contact area of the slide bearing with the bearing holding face is reduced due to the recessed part and thus sliding resistance between the slide bearing and the bearing holding face can be reduced. Therefore, even when the slide bearing is held by the bearing holding face of the case body, the slide bearing can be moved in the axial direction smoothly.

In accordance with an embodiment of the present invention, the motor is provided with an urging member for urging the slide bearing to an output side of the rotation shaft, and the urging member urges the slide bearing so that an axial center of the slide bearing is inclined with respect to an axial center of the rotation shaft, and the recessed part is structured in the opening part on a side where the axial center of the slide bearing is inclined. According to this structure, for example, even when working accuracy of the slide bearing which is structured by resin molding is relatively low, since the urging member urges the slide bearing so that an axial center of the slide bearing is inclined with respect to an axial center of the rotation shaft, rattling of the slide bearing with respect to the bearing holding face is capable of being prevented. On the other hand, when the urging member urges the slide bearing so that the axial center of the slide bearing is inclined with respect to the axial center of the rotation shaft, sliding resistance between the slide bearing and the bearing holding face may become large on a side to which the axial center of the slide bearing is inclined. However, according to this embodiment of the present invention, the recessed part is structured on a side to which the axial center of the slide bearing is inclined. Therefore, the contact area of the slide bearing with the bearing holding face is reduced on the side to which the axial center of the slide bearing is inclined and the sliding resistance between the slide bearing and the bearing holding face is reduced. In this case, it is preferable that a shape of a bottom part which structures the opposite-to-output side end face of the case body when viewed in the axial direction is a roughly oval shape which is structured of two circular arc parts and two straight line parts connecting the two circular arc parts and substantially parallel to each other, the urging member includes a spring part which is abutted with an end face of an opposite-to-output side of the slide bearing, the spring part is structured so as to be extended from one side of the two circular arc parts of the case body to the other side of the two circular arc parts, and the recessed part structured in the opening part is disposed on both sides with respect to a tip end part of the spring part.

In accordance with an embodiment of the present invention, the bearing holder is fixed to the opposite-to-output side end face of the case body by projection welding, a welded part where a protruded part for projection welding is melted and solidified is structured between the opposite-to-output side end face of the case body and the bearing holder, and the recessed part is structured on an inner side in the radial direction with respect to the welded part in the opening part. According to this structure, the protruded part having been melted at the time of projection welding is prevented from being extended and solidified on an inner peripheral side of the bearing holding face by the recessed part. Therefore, smooth movement in the axial direction of the slide bearing is not disturbed due to the protruded part for projection welding. Specifically, it may be structured that a shape of a bottom part which structures the opposite-to-output side end face of the case body is structured in a roughly oval shape when viewed in the axial direction, the roughly oval shape being structured of two circular arc parts and two straight line parts which are substantially parallel to each other and connect the two circular arc parts with each other, a plurality of the recessed parts and a plurality of the welded parts are provided so as to be paired, and the recessed parts are respectively disposed between the welded parts and the outer peripheral face of the slide bearing.

In accordance with an embodiment of the present invention, the case body is structured with a protruded part which is protruded from an edge of the opening part toward an inside of the case body. According to this structure, the contact length of the inner peripheral face of the bearing holder and the inner peripheral face of the bearing holding face including the inner peripheral face of the protruded part with the slide bearing can be set longer in the axial direction by utilizing the inner peripheral face of the protruded part. Therefore, the slide bearing is held further appropriately. In this case, it may be structured that the protruded part protruded toward the inside of the case body is a burr which is structured by performing press punching on the opposite-to-output side end face of the case body toward an output side, and an inner peripheral face of the protruded part includes a sheared face which is structured on the opposite-to-output side and a fracture face which is structured on the output side. Further, it is preferable that the drive coil is sandwiched by two yokes to structure a stator, each of the yokes being provided with a plurality of pole teeth disposed with a predetermined pitch in a circumferential direction, the burr is disposed on an inner peripheral side of curved face parts which are structured in root parts of the pole teeth of the yoke that is abutted with a bottom part structuring the opposite-to-output side end face of the case body, and an inner peripheral face of the burr is used as the bearing holding face of the case body.

In accordance with an embodiment of the present invention, an outer peripheral face of the slide bearing is provided with a cylindrical face which is structured in a cylindrical shape and is disposed on the opposite-to-output side and a diameter reducing face which is disposed on an output side of the rotation shaft and whose outer diameter is reduced toward the output side, and the cylindrical face is slidably held by the inner peripheral face of the bearing holder and the bearing holding face. According to this structure, in comparison with a case that the diameter reducing face is held by the bearing holding face, the contact length of the inner peripheral face of the bearing holder and the bearing holding face of the case body with the slide bearing can be set longer in the axial direction and thus the slide bearing is held further appropriately.

In accordance with an embodiment of the present invention, the motor is provided with a spherical member which is disposed between an end part on the opposite-to-output side of the rotation shaft and the slide bearing, and a center of the spherical member is, for example, disposed in an inside of the case body.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a partly sectional view showing a motor in accordance with an embodiment of the present invention.

FIG. 2 is a view showing the motor which is viewed in an “E-E” direction in FIG. 1.

FIGS. 3(A) and 3(B) are cross-sectional views showing an opposite-to-output side portion of a case body and a slide bearing shown in FIG. 1.

FIG. 4 is a cross-sectional view showing the opposite-to-output side portion of the case body shown in FIG. 1.

FIG. 5 is a view showing the case body which is viewed in the “E-E” direction in FIG. 1.

FIG. 6 is a view showing the slide bearing and the case body which are viewed in the “E-E” direction in FIG. 1.

FIG. 7 is an enlarged showing an “F” part in FIG. 1.

### DETAILED DESCRIPTION OF THE PREFERRED EMBODIMENTS

An embodiment of the present invention will be described below with reference to the accompanying drawings.

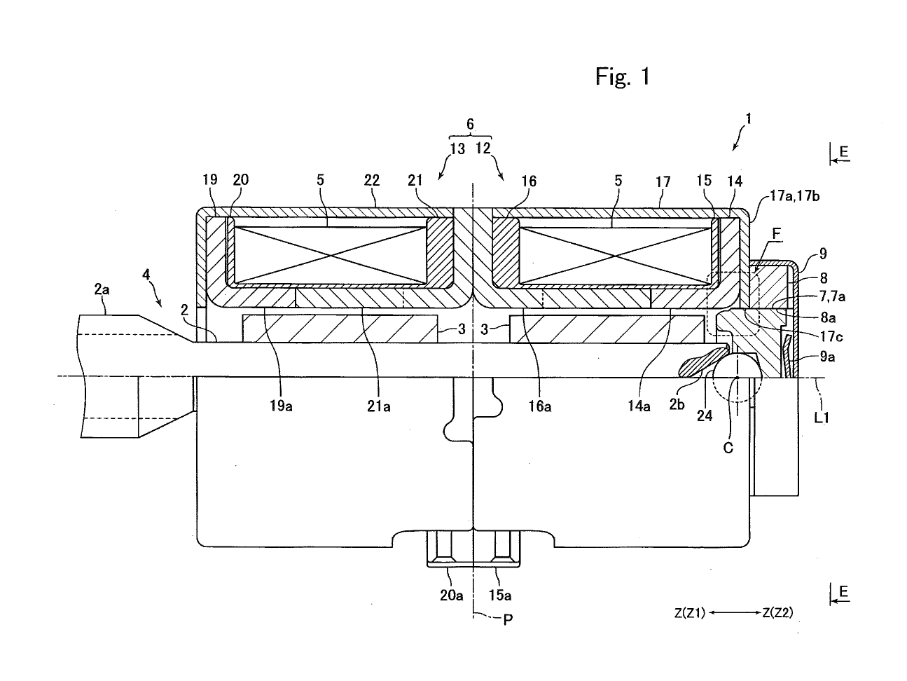

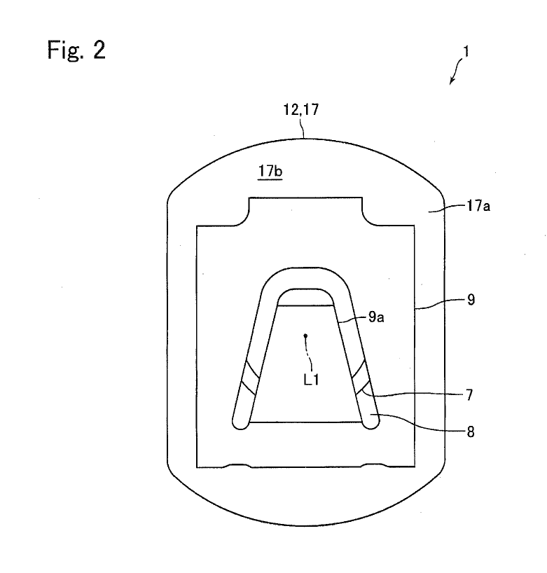

FIG. 1 is a partly sectional view showing a motor 1 in accordance with an embodiment of the present invention. FIG. 2 is a view showing the motor 1 which is viewed in an “E-E” direction in FIG. 1.

The motor 1 in this embodiment is a so-called PM type stepping motor. Further, the motor 1 is a small stepping motor. The motor 1 is, as shown in FIG. 1, provided with a rotor 4 having a rotation shaft 2 and two drive magnets 3 and a stator 6 having two drive coils 5 which are disposed on an outer peripheral side of the drive magnets 3. Further, the motor 1 is provided with an output side bearing (not shown) which supports an end part (not shown) on an output side of the rotation shaft 2, a slide bearing 7 which supports an end part on an opposite-to-output side of the rotation shaft 2 and is movable in an axial direction of the rotation shaft 2, a bearing holder 8 which holds the slide bearing 7, and a plate spring 9 as an urging member for urging the slide bearing 7 toward the output side of the rotation shaft 2.

In the following descriptions, a “Z1” direction side in FIG. 1 which is the output side of the rotation shaft 2 is referred to as the “output side” and a “Z2” direction side in FIG. 1 which is the opposite-to-output side of the rotation shaft 2 is referred to as the “opposite-to-output side”. Further, a “Z” direction in FIG. 1 which is an axial direction of the rotation shaft 2 is referred to as an “axial direction”, a direction perpendicular to the axial direction is referred to as a “radial direction” and a circumferential direction of the rotor 4 is referred to as a “circumferential direction”.

The output side of the rotation shaft 2 is protruded from the stator 6 and a portion protruded from the stator 6 is structured with a lead screw 2a. The lead screw 2a is, for example, threadedly engaged with a moving body such as an optical pickup device to move the moving body.

The drive magnet 3 is a permanent magnet which is structured in a substantially cylindrical tube shape. The two drive magnets 3 are fixed to an outer peripheral face on the opposite-to-output side of the rotation shaft 2 in a separated state with a predetermined space between them in the axial direction. Specifically, the two drive magnets 3 are disposed in a substantially plane symmetrical manner with respect to a plane “P” passing a substantially center in the axial direction of the stator 6. An “N”-pole and an “S”-pole are alternately structured along the circumferential direction on the outer peripheral face of the drive magnet 3.

The stator 6 is provided with a first stator assembly 12 and a second stator assembly 13. The first stator assembly 12 and the second stator assembly 13 are disposed so as to superpose on each other in the axial direction. In this embodiment, the first stator assembly 12 is disposed on the opposite-to-output side and the second stator assembly 13 is disposed on the output side.

The first stator assembly 12 is provided with an outer yoke 14, a bobbin 15 around which a drive coil 5 is wound, an inner yoke 16 which is disposed so as to sandwich the bobbin 15 between the outer yoke 14 and the inner yoke 16, and a case body 17 which covers the respective structural members from an outer side in the radial direction and from the opposite-to-output side. The first stator assembly 12 is disposed on the outer side in the radial direction of the drive magnet 3 which is disposed on the opposite-to-output side.

The bobbin 15 is structured in a tube-like shape with flange which is provided with a flange part at both ends in the axial direction. The drive coil 5 is wound around on the outer peripheral side of the bobbin 15. Further, the bobbin 15 is structured with a terminal block 15a. The terminal block 15a is fixed with terminals (not shown) with which end parts of the drive coil 5 is connected.

The outer yoke 14 is provided with a plurality of pole teeth 14a which is disposed with a predetermined pitch in the circumferential direction. The inner yoke 16 is provides with a plurality of pole teeth 16a which is disposed with a predetermined pitch in the circumferential direction. The pole teeth 14a and 16a are disposed so as to face the outer peripheral face of the drive magnet 3. Further, the pole teeth 14a and the pole teeth 16a are alternately disposed so as to be adjacent to each other in the circumferential direction. The bobbin 15 around which the drive coil 5 is wound is disposed on the outer side in the radial direction of the pole teeth 14a and 16a.

The case body 17 is structured of a thin steel plate and is structured by press working. Further, the case body 17 is structured in a bottomed tube-like shape having a bottom part 17a and the bottom part 17a structures an end face part on the opposite-to-output side of the case body 17. A detailed structure of the case body 17 will be described below.

The second stator assembly 13 is structured so that the same structure as the first stator assembly 12 is disposed in a plane symmetrical manner with respect to the plane “P” passing the substantially center in the axial direction of the stator 6. In other words, the second stator assembly 13 is provided with an outer yoke 19, a bobbin 20, an inner yoke 21 and a case body 22 which respectively correspond to the outer yoke 14, the bobbin 15, the inner yoke 16 and the case body 17 of the first stator assembly 12. As shown in FIG. 1, an end face on the output side of the inner yoke 16 and an end face on the opposite-to-output side of the inner yoke 21 are abutted with each other on the plane “P”.

The bobbin 20 is structured with a terminal block 20a which corresponds to the terminal block 15a of the bobbin 15. Further, the outer yoke 19 is provided with pole teeth 19a corresponding to the pole teeth 14a of the outer yoke 14 and the inner yoke 21 is provided with pole teeth 21a corresponding to the pole teeth 16a of the inner yoke 16.

A shape of the motor 1 which is viewed in the axial direction is, as shown in FIG. 2, a roughly oval-like shape. Specifically, the shape of the motor 1 when viewed in the axial direction is a roughly oval-like shape which is structured of two circular arc parts having the same radius of curvature and the same center of curvature and two parallel straight line parts extended in an upper and lower direction in FIG. 2. In the following descriptions, the upper and lower direction in FIG. 2 where two circular arc parts in an external form of the motor 1 structured in a roughly oval-like shape when viewed in the axial direction are disposed is referred to as an upper and lower direction, and the right and left direction in FIG. 2 where two straight line parts are disposed is referred to as a right and left direction. The drive coils 5 are also covered on both right and left sides by the case bodies 17 and 22 and are covered over the entire periphery by the case bodies 17 and 22. However, in portions where the terminal blocks 15a and 20a are structured, the drive coils 5 may be partly exposed.

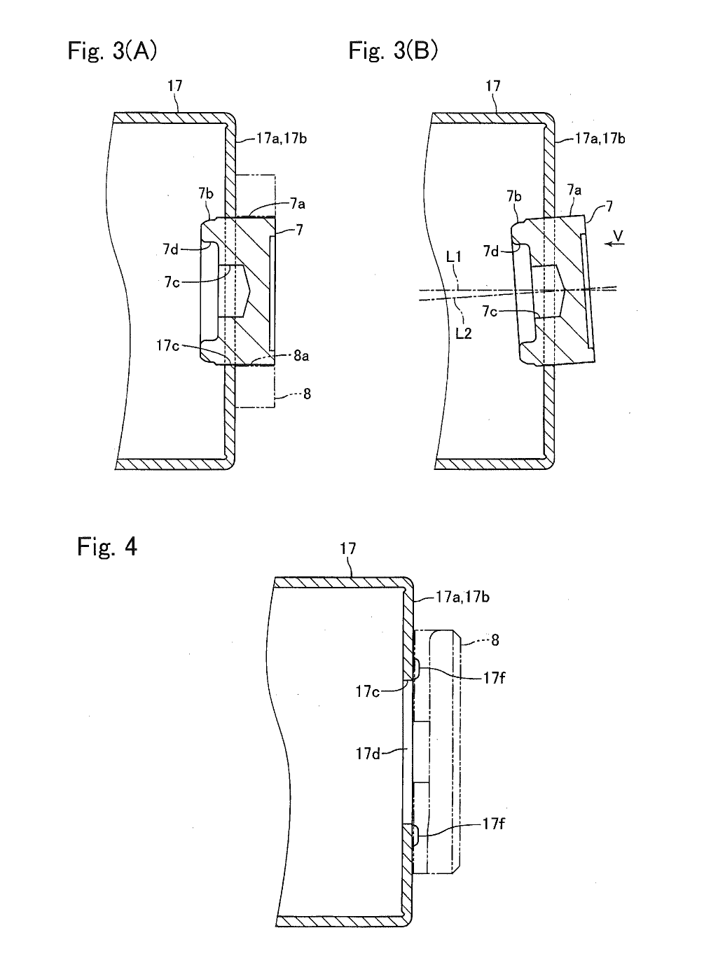

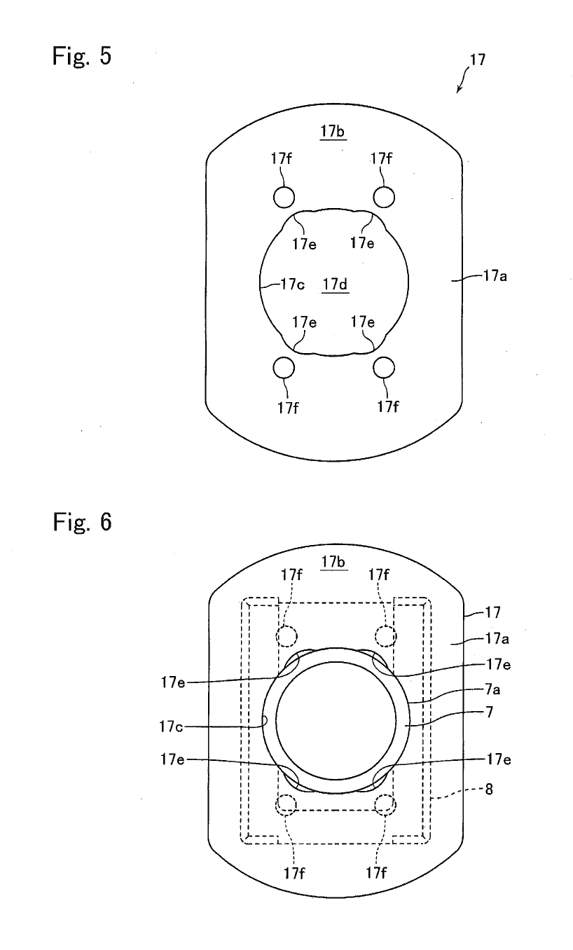

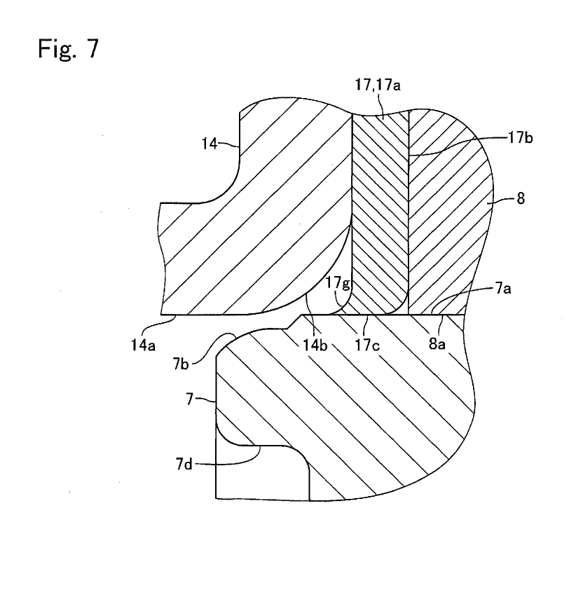

FIGS. 3(A) and 3(B) are cross-sectional views showing an opposite-to-output side portion of the case body 17 and a slide bearing 7 shown in FIG. 1. FIG. 4 is a cross-sectional view showing the opposite-to-output side portion of the case body 17 shown in FIG. 1. FIG. 5 is a view showing the case body 17 which is viewed in the “E-E” direction in FIG. 1. FIG. 6 is a view showing the slide bearing 7 and the case body 17 which are viewed in the “E-E” direction in FIG. 1. FIG. 7 is an enlarged showing an “F” part in FIG. 1.

The slide bearing 7 is structured of resin material. Further, the slide bearing 7 is structured by molding with the use of a die. The slide bearing 7 is structured in a substantially cylindrical shape. An outer peripheral face of the slide bearing 7 is, as shown in FIGS. 3(A) and 3(B), structured of a cylindrical face 7a which is disposed on the opposite-to-output side and a diameter reducing face 7b which is disposed on the output side. The cylindrical face 7a is structured in a cylindrical shape whose outer diameter is constant. The diameter reducing face 7b is structured so that its outer diameter is reduced toward the output side. In this embodiment, a part of an output side end of the outer peripheral face of the slide bearing 7 is structured as the diameter reducing face 7b.

An end face on the output side of the slide bearing 7 is structured with a recessed part 7c in which a spherical member 24 structured in a spherical shape is disposed and a recessed part 7d in which an end part on the opposite-to-output side of the rotation shaft 2 and the spherical member 24 are disposed. The recessed part 7d is structured so as to be connected with an output side end of the recessed part 7c. In other words, the recessed part 7d is structured on the output side with respect to the recessed part 7c. Further, the recessed part 7c is structured in a portion on an inner side in the radial direction on the output side of the cylindrical face 7a and the recessed part 7d is structured in a portion on an inner side in the radial direction of the diameter reducing face 7b. Further, an inner diameter of the recessed part 7d is larger than an inner diameter of the recessed part 7c. Also, an end face on the opposite-to-output side of the rotation shaft 2 is, as shown in FIG. 1, structured with a recessed part 2b in which the spherical member 24 is disposed. In other words, the spherical member 24 is disposed between the end part on the opposite-to-output side of the rotation shaft 2 and the slide bearing 7. The spherical member 24 is rotated together with the rotation shaft 2. In other words, when the rotor 4 is rotated, a slip occurs between a side face and a bottom face of the recessed part 7c and the spherical member 24.

The bearing holder 8 is structured of metal material. Further, the bearing holder 8 is structured by die casting with the use of a die or the like. The bearing holder 8 is structured in a flat and substantially rectangular prism shape. The bearing holder 8 is structured with a circular through hole penetrating in the axial direction and the bearing holder 8 holds the slide bearing 7 on an inner peripheral face 8a of the through hole so as to be movable in the axial direction. The bearing holder 8 is fixed to an end face 17b on the opposite-to-output side (opposite-to-output side end face) of the case body 17 which is a side face on the opposite-to-output side of the bottom part 17a. Specifically, the bearing holder 8 is fixed to the opposite-to-output side end face 17b by welding. In this embodiment, the bearing holder 8 is fixed to the opposite-to-output side end face 17b by projection welding. Further, the entire bearing holder 8 is, as shown in FIG. 1, disposed on the outer side of the case body 17.

The shape of the motor 1 when viewed in the axial direction is, as described above, a roughly oval shape and thus a shape of the bottom part 17a of the case body 17 when viewed in the axial direction is also a roughly oval shape which is structured of two circular arc parts and two straight line parts which connect the two circular arc parts with each other and are substantially parallel to the upper and lower direction. The bottom part 17a of the case body 17 is structured with a substantially circular opening part 17d so as to be coincided with the inner peripheral face 8a of the bearing holder 8. In other words, the substantially circular opening part 17d is provided with a bearing holding face 17c having substantially the same inner diameter as the inner peripheral face 8a of the bearing holder 8 so as to movably hold the cylindrical face 7a of the slide bearing 7 in the axial direction together with the inner peripheral face 8a of the bearing holder 8. The opening part 17d is, as shown in FIG. 5, structured with recessed parts 17e which are recessed to an outer side in the radial direction from the bearing holding face 17c. In this embodiment, four recessed parts 17e are structured in the opening part 17d. Specifically, two recessed parts 17e are respectively structured on both end sides in the upper and lower direction of the opening part 17d. A spring part 9a which is structured in a plate spring 9 described below and is abutted with an end face on the opposite-to-output side of the slide bearing 7 is structured so as to be extended from the lower circular arc part, which is one of the two circular arc parts forming the bottom part 17a of the case body 17, toward the upper circular arc part, which is the other of the two circular arc parts. Therefore, two recessed parts 17e which are respectively structured on both end sides in the upper and lower direction of the opening part 17d are structured so as to interpose the spring part 9a from both sides in the right and left direction. A side face of the recessed part 17e is structured in a curved face having a circular arc shape. An inner diameter of the opening part 17d except the recessed parts 17e (in other words, an inner diameter of the portion where the bearing holding face 17c is structured) is substantially equal to an inner diameter of the inner peripheral face 8a of the bearing holder 8. Further, the inner diameter of the opening part 17d except the recessed parts 17e and the inner diameter of the inner peripheral face 8a are slightly larger than the outer diameter of the slide bearing 7 so that the slide bearing 7 is capable of sliding in the axial direction.

As described above, the bearing holder 8 is fixed to the opposite-to-output side end face 17b of the case body 17 by projection welding. Before the bearing holder 8 is welded, the opposite-to-output side end face 17b is, as shown in FIGS. 4 and 5, structured with protruded parts 17f for projection welding. The protruded parts 17f are melted at the time of projection welding. After the projection welding has been performed welded parts (not shown) where the protruded parts 17f are melted and solidified are formed between the opposite-to-output side end face 17b and the bearing holder 8.

In this embodiment, four protruded parts 17f are structured on the opposite-to-output side end face 17b. Specifically, the protruded parts 17f are structured on the respective outer sides in the radial direction of the four recessed parts 17e which are structured in the opening part 17d. In other words, the recessed part 17e is structured in the opening part 17d on the inner side in the radial direction of the protruded part 17f. Specifically, the recessed part 17e is disposed between the welded part where the protruded part 17f has been melted and solidified and the cylindrical face 7a which is the outer peripheral face of the slide bearing 7. Further, the motor 1 in this embodiment is a small stepping motor and thus the protruded part 17f is structured in the vicinity of the recessed part 17e.

Further, as described above, the case body 17 is formed by press working and the opening part 17d is formed by press punching. In this embodiment, a die for press punching is entered in the inside of the case body 17 from the opposite-to-output side end face 17b and the opening part 17d is formed. Therefore, the bottom part 17a is, as shown in FIG. 7, structured with a burr 17g as a protruded part which is protruded from the opening part 17d toward the inside of the case body 17 (in other words, protruded toward the output side). The burr 17g is, as shown in FIG. 7, disposed on inner peripheral sides of curved face parts 14b which are structured in root parts of the pole teeth 14a of the outer yoke 14. Further, when the opposite-to-output side end face 17b of the case body 17 is worked by press punching, a sheared face and a fracture face are structured on the output side. In this embodiment, the sheared face and the fracture face are utilized as the bearing holding face 17c. In other words, the bearing holding face 17c is structured of the sheared face structured on the opposite-to-output side and the fracture face structured on the output side. In this embodiment, the pole teeth 14a are structured by successively performing drawing work, punching work and the like by a press and the curved face parts 14b which are structured at the root parts of the pole teeth 14a are structured at the time of the drawing work of the pole teeth 14a.

The plate spring 9 is fixed to the opposite-to-output side of the bearing holder 8. A spring part 9a which is abutted with an end face on the opposite-to-output side of the slide bearing 7 is, as shown in FIG. 2, formed at a center part of the plate spring 9 so that the spring part 9a is extended from a lower circular arc part side toward an upper circular arc part side of the two circular arc parts forming the bottom part 17a of the case body 17. The spring part 9a urges the rotation shaft 2 to the output side through the slide bearing 7 and the spherical member 24. In the right and left direction, the spring part 9a is abutted with a substantially center portion of the slide bearing 7. Further, in the upper and lower direction, the spring part 9a is abutted with the slide bearing 7 on one side in the upper and lower direction (specifically, upper side in FIG. 2) with respect to an axial center “L1” of the rotation shaft 2. Therefore, as shown in FIG. 3(B), an urging force in a direction shown by the arrow “V” is acted on the slide bearing 7 and a moment whose axial direction is the right and left direction is acted on the slide bearing 7. Therefore, an axial center “L2” of the slide bearing 7 is inclined with respect to the axial center “L1” of the rotation shaft 2 so that contact pressures of both upper and lower end portions of the bearing holding face 17c with the outer peripheral face of the slide bearing 7 are increased. In FIG. 3(B), the axial center “L2” is shown so as to be inclined larger than an actual inclination of the axial center “L2” with respect to the axial center “L1” for convenience.

A part on the output side of the slide bearing 7 is disposed in the inside of the case body 17. As shown in FIG. 1, an output side portion of the slide bearing 7 is disposed in the inside of the case body 17 so that the center “C” of the spherical member 24 is disposed in the inside of the case body 17. Further, the slide bearing 7 is held by the inner peripheral face 8a of the bearing holder 8 and the bearing holding face 17c of the case body 17 so as to be movable in the axial direction. Specifically, the cylindrical face 7a of the slide bearing 7 is held by the inner peripheral face 8a and the bearing holding face 17c. In this embodiment, an opposite-to-output side end of the rotor 4 is supported in the radial direction and the thrust direction by the slide bearing 7, the bearing holder 8, the bottom part 17a of the case body 17, the plate spring 9 and the spherical member 24.

In this embodiment, the output side bearing which supports an end part on the output side of the rotation shaft 2 is fixed in the axial direction and the radial direction. On the other hand, the slide bearing 7 is movable in the axial direction. Further, the inner diameter of the opening part 17d except the recessed parts 17e and the inner diameter of the inner peripheral face 8a of the bearing holder 8 are slightly larger than the outer diameter of the slide bearing 7 and thus the slide bearing 7 is slightly movable in the radial direction. Further, in this embodiment, when working accuracy of the outer peripheral face of the slide bearing 7, working accuracy of the inner peripheral face 8a of the bearing holder 8, and working accuracy of the opening part 17d of the case body 17 are compared, the working accuracy of the inner peripheral face 8a is the highest and the working accuracy of the opening part 17d is higher than the working accuracy of the outer peripheral face of the slide bearing 7. In this embodiment, the working accuracy means dimensional accuracy and cylindricality.

As described above, in this embodiment, a part on the output side of the slide bearing 7 is disposed in the inside of the case body 17 and the slide bearing 7 is slidably held by the inner peripheral face 8a of the bearing holder 8 and the bearing holding face 17c of the case body 17 so as to be movable in the axial direction. Therefore, even when a thickness of the bearing holder 8 in the axial direction is reduced, a contact length in the axial direction of the inner peripheral face 8a of the bearing holder 8 and the bearing holding face 17c of the case body 17 with the outer peripheral face of the slide bearing 7 is secured by utilizing the bearing holding face 17c. Therefore, even when the thickness of the bearing holder 8 in the axial direction is reduced, the slide bearing 7 is appropriately held by the inner peripheral face 8a of the bearing holder 8 and the bearing holding face 17c and thus the slide bearing 7 is appropriately guided in the axial direction by the inner peripheral face 8a of the bearing holder 8 and the bearing holding face 17c of the case body 17 and the slide bearing 7 is smoothly moved in the axial direction. As a result, in this embodiment, the size of the motor 1 is reduced in the axial direction. Further, in this embodiment, the entire bearing holder 8 is disposed on the outer side of the case body 17 and thus the size in the radial direction of the case body 17 can be determined regardless of the bearing holder 8. Therefore, in this embodiment, the size of the motor 1 can be reduced in the radial direction. As described above, in the embodiment of the present invention, even when the slide bearing 7 is capable of being smoothly moved in the axial direction, the size of the motor 1 can be reduced in the axial direction and the radial direction.

In this embodiment, the burr 17g which is protruded from the opening part 17d to the inside of the case body 17 is formed in the bottom part 17a of the case body 17. Therefore, the contact length of the inner peripheral face 8a of the bearing holder 8 and the inner peripheral face of the bearing holding face 17c including the inner peripheral face of the burr 17g with the outer peripheral face of the slide bearing 7 can be set longer in the axial direction by utilizing the inner peripheral face of the burr 17g. Further, in this embodiment, the cylindrical face 7a of the slide bearing 7 is slidably held by the bearing holding face 17c and thus, in comparison with a case that the diameter reducing face 7b of the slide bearing 7 is oppositely disposed to the bearing holding face 17c, the contact length of the bearing holding face 17c with the outer peripheral face of the slide bearing 7 can be set longer in the axial direction. Therefore, in this embodiment, the slide bearing 7 is slidably held further appropriately.

In this embodiment, the recessed part 17e which is recessed to the outer side in the radial direction with respect to the bearing holding face 17c is formed in the opening part 17d. Therefore, the contact area of the outer peripheral face of the slide bearing 7 with the bearing holding face 17c is reduced. Therefore, in this embodiment, even when the slide bearing 7 is held by the bearing holding face 17c which is structured of the sheared face and the fracture face, sliding resistance between the outer peripheral face of the slide bearing 7 and the bearing holding face 17c is reduced and, as a result, the slide bearing 7 is moved in the axial direction smoothly.

In this embodiment, the slide bearing 7 is urged by the spring part 9a of the plate spring 9 so that the axial center “L2” of the slide bearing 7 is inclined with respect to the axial center “L1” of the rotation shaft 2. Therefore, even when working accuracy of the slide bearing 7 which is formed by resin molding is low, rattling of the slide bearing 7 with respect to the bearing holding face 17c is capable of being prevented. On the other hand, in this embodiment, the axial center “L2” of the slide bearing 7 is inclined with respect to the axial center “L1” of the rotation shaft 2 by the spring part 9a of the plate spring 9 so that contact pressures of both upper and lower end portions of the bearing holding face 17c with the outer peripheral face of the slide bearing 7 are increased. Therefore, sliding resistances between both upper and lower end portions of the opening part 17d and the outer peripheral face of the slide bearing 7 may be increased. However, in this embodiment, the recessed part 17e is structured in each of both upper and lower end portions of the opening part 17d. Therefore, the contact area of the outer peripheral face of the slide bearing 7 with the bearing holding face 17c is reduced on both upper and lower end portions of the opening part 17d to reduce the sliding resistance between the outer peripheral face of the slide bearing 7 and the bearing holding face 17c. As a result, in this embodiment, even when the slide bearing 7 is urged by the plate spring 9 so that the axial center “L2” of the slide bearing 7 is inclined with respect to the axial center “L1” of the rotation shaft 2, the slide bearing 7 can be moved in the axial direction smoothly.

In this embodiment, the recessed part 17e is formed in the opening part 17d on an inner side in the radial direction of the protruded part 17f. Specifically, the recessed part 17e is disposed between the protruded part 17f and the outer peripheral face of the slide bearing 7. Therefore, the protruded part 17f having been melted at the time of projection welding is prevented from being extended and solidified on an inner peripheral side of the bearing holding face 17c by the recessed part 17e. Therefore, in this embodiment, smooth movement in the axial direction of the slide bearing 7 is not disturbed due to the welding of the protruded part 17f.

In this embodiment, the output side portion of the slide bearing 7 is located at the inside of the case body 17 so that the center “C” of the spherical member 24 is disposed in the inside of the case body 17. Therefore, a distance between the output side bearing which supports the end part on the output side of the rotation shaft 2 and the slide bearing 7 can be shortened. Therefore, rattling of the slide bearing 7 is reduced which is slightly movable in the radial direction with the output side bearing fixed in the axial direction and the radial direction as a supporting point.

Although the present invention has been shown and described with reference to a specific embodiment, various changes and modifications will be apparent to those skilled in the art from the teachings herein.

In the embodiment described above, the recessed part 17e is structured in each of the upper and lower end portions of the opening part 17d. However, the present invention is not limited to this embodiment. For example, the recessed part 17e may be formed in one of the upper end portion and the lower end portion of the opening part 17d. Further, the recessed part 17e may be structured in the respective right and left end portions of the opening part 17d or may be structured in one of the right and left end portions of the opening part 17d. In addition, the recessed part 17e may be structured with an equal angular pitch in the circumferential direction. Further, no recessed part 17e may be structured in the opening part 17d.

In the embodiment described above, the slide bearing 7 is urged by the plate spring 9 so that the axial center “L2” of the slide bearing 7 is inclined with respect to the axial center “L1” of the rotation shaft 2. However, the present invention is not limited to this embodiment. For example, when the slide bearing 7 is worked with a high degree of accuracy, the slide bearing 7 may be urged by the plate spring 9 so that the axial center “L2” and the axial center “L1” are substantially coincided with each other without inclining the axial center “L2” of the slide bearing 7 with respect to the axial center “L1” of the rotation shaft 2. Further, in the embodiment described above, the slide bearing 7 is urged by the plate spring 9. However, the slide bearing 7 may be urged by another spring member such as a coil spring or by an elastic member such as rubber. In other words, the urging member for urging the slide bearing 7 may be a spring member other than the plate spring 9 or an elastic member such as rubber.

In the embodiment described above, the bearing holder 8 is fixed to the opposite-to-output side end face 17b by projection welding. However, the present invention is not limited to this embodiment. For example, the bearing holder 8 may be fixed to the opposite-to-output side end face 17b by welding other than projection welding or by using an adhesive. In this case, no protruded part 17f is structured on the opposite-to-output side end face 17b.

In the embodiment described above, the burr 17g is structured in the bottom part 17a of the case body 17 but the burr 17g may be removed after press working. Further, in the embodiment described above, the center “C” of the spherical member 24 is disposed in the inside of the case body 17. However, the center “C” of the spherical member 24 may be disposed on the outer side of the case body 17.

In the embodiment described above, the stator 6 is structured of the first stator assembly 12 and the second stator assembly 13. However, the stator 6 may be structured of three or more stator assemblies. Further, in the embodiment described above, a shape when the motor 1 is viewed in the axial direction is a roughly oval shape. However, a shape when the motor 1 is viewed in the axial direction may be a substantially circular shape.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotation shaft;
a drive magnet which is fixed to the rotation shaft;
a drive coil which is disposed on an outer peripheral side of the drive magnet;
a case body which covers at least a part of an outer peripheral face of the drive coil;
a slide bearing which supports an end part on an opposite-to-output side of the rotation shaft and is movable in an axial direction of the rotation shaft; and
a bearing holder which holds the slide bearing movably in the axial direction through an inner peripheral face of the bearing holder;
wherein the bearing holder is fixed to an opposite-to-output side end face of the case body and an entire bearing holder is disposed on an outer side of the case body;
wherein the case body is structured with an opening part having a bearing holding face for slidably supporting the slide bearing together with an inner peripheral face of the bearing holder;
wherein a part of the slide bearing is disposed in an inside of the case body; and
wherein the slide bearing is held by the inner peripheral face of the bearing holder and the bearing holding face of the case body so as to be movable in the axial direction.

2. The motor according to claim 1, wherein the opening part is structured with a recessed part which is recessed to an outer side in a radial direction of the rotation shaft with respect to the bearing holding face.

3. The motor according to claim 2, further comprising an urging member for urging the slide bearing to an output side of the rotation shaft,
wherein the urging member urges the slide bearing so that an axial center of the slide bearing is inclined with respect to an axial center of the rotation shaft, and the recessed part is structured in the opening part on a side where the axial center of the slide bearing is inclined.

4. The motor according to claim 3, wherein
a shape of a bottom part which structures the opposite-to-output side end face of the case body when viewed in the axial direction is a roughly oval shape which is structured of two circular arc parts and two straight line parts connecting the two circular arc parts and substantially parallel to each other,
the urging member includes a spring part which is abutted with an end face of an opposite-to-output side of the slide bearing,
the spring part is structured so as to be extended from one side of the two circular arc parts of the case body to an other side of the two circular arc parts, and
the recessed part structured in the opening part is disposed on both sides with respect to a tip end part of the spring part.

5. The motor according to claim 3, wherein
an outer peripheral face of the slide bearing is provided with a cylindrical face which is structured in a cylindrical shape and is disposed on the opposite-to-output side and a diameter reducing face which is disposed on an output side of the rotation shaft and whose outer diameter is reduced toward the output side, and
the cylindrical face is slidably held by the inner peripheral face of the bearing holder and the bearing holding face of the case body.

6. The motor according to claim 2, wherein
the bearing holder is fixed to the opposite-to-output side end face of the case body by projection welding,
a welded part where a protruded part for projection welding has been melted and solidified is structured between the opposite-to-output side end face of the case body and the bearing holder, and
the recessed part is structured in the opening part on an inner side in the radial direction with respect to the welded part.

7. The motor according to claim 6, wherein
a shape of a bottom part which structures the opposite-to-output side end face of the case body is structured in a roughly oval shape when viewed in the axial direction, the roughly oval shape being structured of two circular arc parts and two straight line parts which are substantially parallel to each other and connect the two circular arc parts with each other,
a plurality of the recessed parts and a plurality of the welded parts are provided so as to be paired, and
the recessed parts are respectively disposed between the welded parts and the outer peripheral face of the slide bearing.

8. The motor according to claim 7, further comprising an urging member for urging the slide bearing to an output side of the rotation shaft,
wherein the urging member urges the slide bearing so that an axial center of the slide bearing is inclined with respect to an axial center of the rotation shaft, and the recessed part is structured in the opening part on a side where the axial center of the slide bearing is inclined.

9. The motor according to claim 8, wherein
the urging member includes a spring part which is abutted with an end face of an opposite-to-output side of the slide bearing,
the spring part is structured so as to be extended from one side of the two circular arc parts of the case body to an other side of the two circular arc parts, and
the recessed part structured in the opening part is disposed on both sides with respect to a tip end part of the spring part.

10. The motor according to claim 1, wherein the case body is structured with a protruded part which is protruded from an edge of the opening part toward an inside of the case body.

11. The motor according to claim 10, wherein
the protruded part protruded toward the inside of the case body is a burr which is structured by performing press punching on the opposite-to-output side end face of the case body toward an output side, and
an inner peripheral face of the protruded part includes a sheared face which is structured on the opposite-to-output side and a fracture face which is structured on the output side.

12. The motor according to claim 10, wherein
the drive coil is sandwiched by two yokes to structure a stator, each of the yokes being provided with a plurality of pole teeth disposed with a predetermined pitch in a circumferential direction,
the burr is disposed on an inner peripheral side of curved face parts which are structured in root parts of the pole teeth of the yoke that is abutted with a bottom part structuring the opposite-to-output side end face of the case body, and
an inner peripheral face of the burr is used as the bearing holding face of the case body.

13. The motor according to claim 12, further comprising an urging member for urging the slide bearing to an output side of the rotation shaft,
wherein the urging member urges the slide bearing so that an axial center of the slide bearing is inclined with respect to an axial center of the rotation shaft,
wherein the opening part is structured with a recessed part which is recessed to an outer side in a radial direction of the rotation shaft with respect to the bearing holding face, and the recessed part is structured in the opening part on a side where the axial center of the slide bearing is inclined.

14. The motor according to claim 13, wherein
a shape of the bottom part which structures the opposite-to-output side end face of the case body is structured in a roughly oval shape when viewed in the axial direction, the roughly oval shape being structured of two circular arc parts and two straight line parts which are substantially parallel to each other and connect the two circular arc parts with each other,
the urging member includes a spring part which is abutted with an end face of an opposite-to-output side of the slide bearing,
the spring part is structured so as to be extended from one side of the two circular arc parts of the case body to an other side of the two circular arc parts, and
the recessed part structured in the opening part is disposed on both sides with respect to a tip end part of the spring part.

15. The motor according to claim 12, wherein
the opening part is structured with a recessed part which is recessed to an outer side in a radial direction of the rotation shaft with respect to the bearing holding face,
the bearing holder is fixed to the opposite-to-output side end face of the case body by projection welding,
a welded part where a protruded part for projection welding has been melted and solidified is structured between the opposite-to-output side end face of the case body and the bearing holder, and
the recessed part is structured on an inner side in the radial direction with respect to the welded part in the opening part.

16. The motor according to claim 15, wherein
a shape of the bottom part which structures the opposite-to-output side end face of the case body is structured in a roughly oval shape when viewed in the axial direction, the roughly oval shape being structured of two circular arc parts and two straight line parts which are substantially parallel to each other and connect the two circular arc parts with each other,
a plurality of the recessed parts and a plurality of the welded parts are provided so as to be paired, and
the recessed parts are respectively disposed between the welded parts and the outer peripheral face of the slide bearing.

17. The motor according to claim 16, further comprising an urging member for urging the slide bearing to an output side of the rotation shaft,
wherein the urging member urges the slide bearing so that an axial center of the slide bearing is inclined with respect to an axial center of the rotation shaft, and the recessed part is structured in the opening part on a side where the axial center of the slide bearing is inclined.

18. The motor according to claim 12, wherein
an outer peripheral face of the slide bearing is provided with a cylindrical face which is structured in a cylindrical shape and is disposed on the opposite-to-output side and a diameter reducing face which is disposed on an output side of the rotation shaft and whose outer diameter is reduced toward the output side, and
the cylindrical face is held by the inner peripheral face of the bearing holder and the bearing holding face of the case body.

19. The motor according to claim 1, further comprising a spherical member which is disposed between an end part on the opposite-to-output side of the rotation shaft and the slide bearing,
wherein a center of the spherical member is disposed in the inside of the case body.
